(19) United States
(12) Patent Application Publication
(10) Pub. No.: US 2010/0285239 A1
(43) Pub. Date: Nov. 11, 2010

(54) METHOD OF AND HOT-DIP INSTALLATION FOR STABILIZING A STRIP GUIDED BETWEEN STRIPPING DIES OF THE HOT-DIP COATING INSTALLATION AND PROVIDED WITH A COATING

(76) Inventors: Holger Behrens, Erkrath (DE); Michael Zielenbach, Siegen (DE); Hans-Georg Hartung, Pulheim (DE); Pascal Fontaine, Langenfeld (DE)

Correspondence Address: ABELMAN, FRAYNE & SCHWAB, 666 THIRD AVENUE, 10TH FLOOR, NEW YORK, NY, 10017, US

(21) Appl. No.: 12/733,274

(22) PCT Filed: Aug. 22, 2008
(86) PCT No.: PCT/EP2008/006923

§ 371 Date: May 7, 2010

(30) Foreign Application Priority Data
Aug. 22, 2007 (DE) 102007039690.4

(51) Int. Cl. B05D 3/12; B05C 11/00

(52) U.S. Cl. 427/595; 118/708

(57) ABSTRACT

The invention relates to a method of stabilizing a strip guided between stripping dies of a hot-dip coating installing and provided with a coating, and also to a corresponding hot-dip coating installation. In this context, stabilizing forces are applied to the strip on the basis of the detected strip position by coils which are arranged downstream of the stripping dies in the strip displacement direction and act electromagnetically and in a contactless manner on the displaceable steel strip. In order to improve the stabilization of the strip in the region of the stripping die, the invention proposes that the distance between the line of action of the strip-stabilizing means and the stripping dies be adjusted to a value≦a distance threshold value which is determined as a function of the strip width taking into account a coefficient φ, wherein the coefficient φ is calculated as a function of the strip thickness and the strip tension.

The invention relates to a method of stabilizing a strip guided between stripping dies of a hot-dip coating installation and provided with a coating, and also to a corresponding hot-dip coating installation. In this context, stabilizing forces are applied to the strip on the basis of the detected strip position by means of coils which are arranged downstream of the stripping dies in the strip displacement direction and act electromagnetically and in a contactless manner on the displaceable steel strip.

Electromagnetic stabilization is based on the induction principle in order to generate, with magnetic field, forces acting transverse to a ferromagnetic steel strip. Thereby, the position of the steel strip between two opposite electromagnetic inductors (electromagnets) can be changed in a contactless manner. Different types of such systems are known. They are used, e.g., in hot-dip coating installations above so-called stripping dies. Different regulation and control concepts are known (e.g., DE 10 2005 060 058 A1, WO 2006/006911 A1).

Stripping dies are used in steel strip hot-dip coating installations to obtain a definite amount of a coating medium on the strip surface. The quality of the coating (the uniformity of deposition, the precision of the layer thickness, homogeneous surface sheen) substantially depends on the uniformity of the stripping die medium (air or nitrogen) and on the strip movement in the die region. The strip movements are influenced by a circularity error of rollers or, e.g., pulse action of air in the region of the tower cooler of the hot-dip coating installation. With an increased strip movement in the stripping die, the quality of the coating or the uniformity of the coating of the displaceable, through the die, strip is reduced.

By providing strip stabilization systems downstream in the strip displacement direction, the strip movement within the stripping die can be damped or reduced, so that improvement of the coating precision and the coating uniformity of the liquid metal on the steel strip are achieved. Those can be, e.g., electromagnetically acting actuators, which apply generated forces in contactless manner to the displacing through steel strip and, thus, change the strip position.

With the known systems, the strip stabilization means, due to their location, in the strip displacement direction, downstream of the stripping die, are able to control the strip movement in the stripping die only to a limited extent. Damping of oscillations above the stripping die within the strip stabilization means with strip stabilizing coils is very effective. In the region of the die, the action, however, is noticeably reduced with an increased distance between the same and the stabilization unit. The position of the strip stabilization means is fixed, corresponding to actual conditions, without a need to describe physical dependencies. Therefore, the object is to position the strip stabilization means as close to the stripping die as possible whenever the strip stabilization means is used, without taking into account the interrelation between the distance and action.

Therefore, an object of the invention is to improve the strip stabilization in the region of the stripping die.

This object is achieved with the method according to claim 1. This one is characterized in that a distance (of action) of the strip stabilization from the stripping dies is adjusted to a value smaller then or equal to a distance threshold value which is determined as a function of the strip width, taking into account a coefficient φ, wherein the coefficient φ is calculated as a function of strip thickness and strip tension.

The measurement value of the strip position represents, within the scope of the present description, a timely and/or localized change of the distance of the strip from a straight reference line transverse to the strip displacement direction, i.e., the strip position represents the strip profile and/or its oscillation behavior as a function of time.

The term “strip stabilization” encompasses, within the scope of the present description, two essential aspects: on one hand, the strip stabilization means flatness of a wave-shaped strip profile and, on the other hand, this term means damping oscillations of the strip. Both aspects of the strip stabilization can be realized, independently from each other, or in combination, or simultaneously, with a suitable control circuit.

The essential advantage of the claimed limitation of the distance can be seen in that with adjustment of the distance to a value below the calculated, according to the invention, distance threshold value, a noticeably better effectiveness for both aspects of the target strip stabilization is achieved. Contrary to this, at distances above the distance threshold value, the effectiveness of the strip stabilization is noticeably reduced or the strip, despite the stabilization control, is as unstable as without control (opposite effect).

In an ideal case, the distance is equal to nill, i.e., when the strip stabilization means is arranged at the height of the stripping die, when the stabilization takes place immediately at the height of the stripping die, and the strip is optimally stably held during the measurement process. However, this arrangement is, as a rule, not technically feasible because of place shortage. Therefore, the distance should be as small as possible, and maximum be adjusted to the value of the calculated, according to the invention, distance threshold value.

Electromagnetic forces are applied by coils arranged in pairs opposite each other on each side of the strip, and the distance of which from the stripping die varies.

Advantageously, with the inventive method, the strip position is measured within the coil arrangement and, actually, in a spatial proximity to the coil arrangement.

Additionally, the strip position is determined above and below the coil arrangement.

According to one embodiment of the invention, several coils are provided on each side of the strip, with the outwardly located coils being adjustably arranged above the displaceable-through strip edges parallel to the strip plane. This arrangement provides, advantageously for an optimal effect during flattening of the strip profile.

The distance of the strip stabilizing device, further strip stabilization means, from the stripping dies, should not exceed, at wider strips (B>1400 mm), the strip width. With smaller strips (B<1400 mm), the distance can amount to 1.75 times of the strip width. The distance is based on the Saint-Venant's principle, which states that with an increasing distance of an applied force to, e.g., a tensioned steel strip, its effect on the overall condition is decreased.

The basis for the inventive solution is the positioning of the strip stabilization means relative to the stripping die or dies, taking into account the tension mechanism.

The effect of a selective load application in a given load system is determined according to the Saint-Venant principle only in a small region around a load application point. Local irregular force distribution, which takes place upon introduction of forces, abates very rapidly. This principle is usually used at strength calculations for dimensioning of the components and is used here for determining strip stabilization effect in the stripping die region.

In order to achieve a satisfactory effect in the stripping die on the strip profile and the strip movement (oscillation) to substantially change it or damp it, the distance between the strip stabilization action and the stripping die must be selected, according to Saint-Venant's principle, in a fixed region or should not exceed a peak value in form of a distance threshold value.

In this respect, the distance, i.e., the length of the steel strip in which the strip stabilization effect is to be expected, is selected according to the following rule:

Distance≦Distance Threshold Value=φ*characteristic Length
with φ=Function (strip thickness, strip tension)

The above-mentioned object is further achieved with the claimed hot-dip coating installation. This one is characterized in that the distance between (action) of the strip-stabilization means and the stripping dies is adjusted to a value smaller than or equal to distance threshold value which is determined as a function of the strip width taking into account a coefficient φ, wherein the coefficient φ is a function of the strip thickness and the strip tension.

The advantages of this installation correspond to above-mentioned advantages discussed with reference to the claimed method.

The solution according to the invention will be explained in details below with reference to the drawings.

The drawings show:

FIG. 1 schematically arrangement of strip stabilizing coils;

FIG. 2 strip profiles;

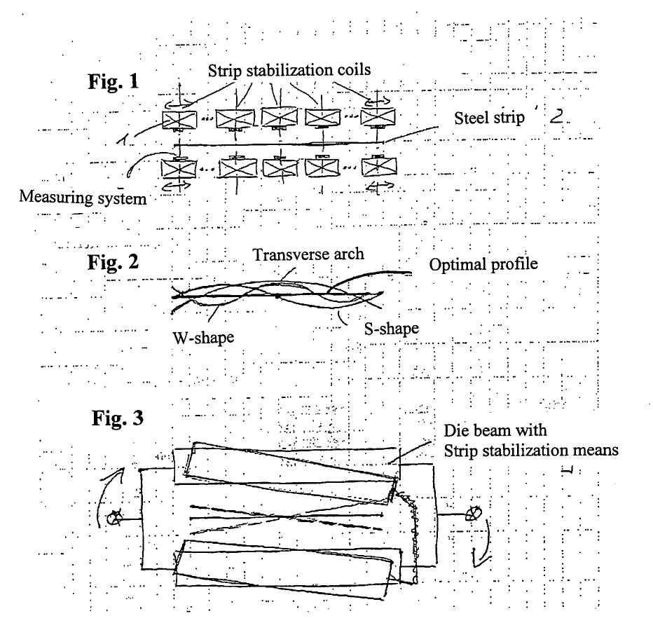

FIG. 3 schematically, arrangement of the die beam;

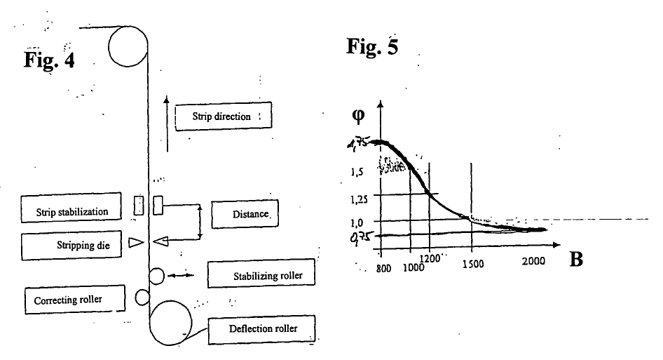

FIG. 4 strip stabilization system;

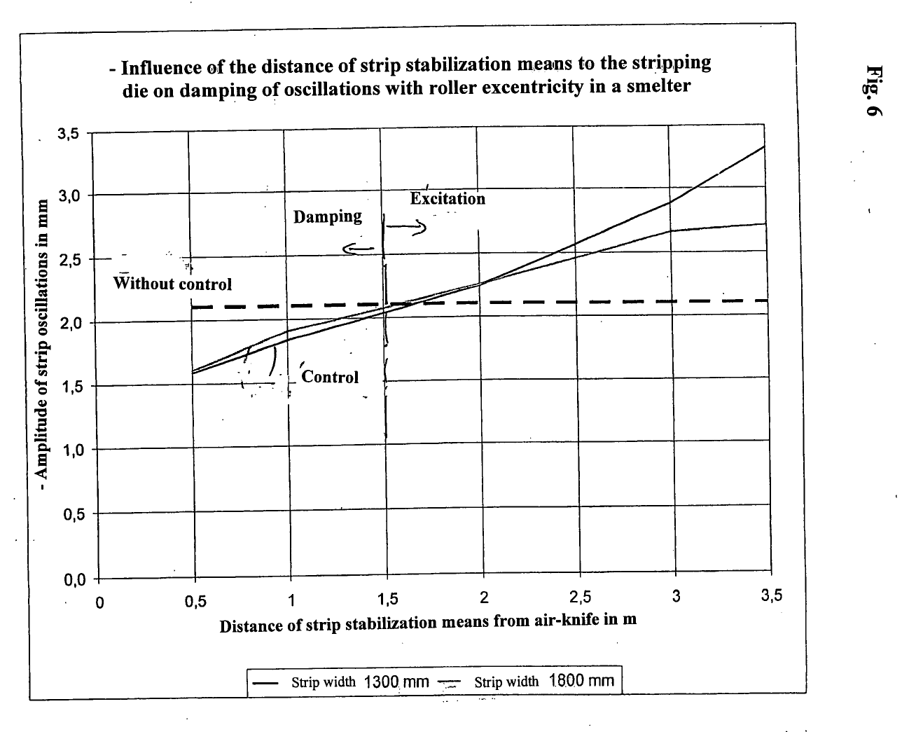

FIG. 5 dependence of the coefficient φ from strip width; and

FIG. 6 relationship between strip oscillations and the distance of the strip stabilization means from the stripping die.

The arrangement of the strip stabilization means and the stripping dies in principle is shown in FIG. 4.

The distance threshold value, in accordance with Saint Venant's principle, amounts to, for displaceable wide steel strips, to about the strip width, and for more narrow strips, to maximum 1.75 times of the strip width (see FIG. 5). At a larger distance, the effect of the strip stabilization with respect to the flatness of the strip profile (transverse arch, S-shape, see FIG. 2) is greatly diminished or is not any more discernable.

The force application point of the stabilization means is then lies too far from the die lip to adequately influence the strip deformation such as, e.g., reduction of the transverse arch.

Further, measurements and simulations can insure that the influence of oscillation (damping of the amplitude of the strip oscillation) in the die slit likewise depends on the distance of the power application point from the die slit-operating point.

This produces the following interrelation:

Distances≦φ(strip thickness, strip tension)*strip width=Distance threshold value.

The coefficient φ is analyzed and determined, dependent on strip tension and strip thickness, analytically by FEM simulations and also empirically on strip handling installations. This interrelation is shown in FIG. 5. With reduced strip width, the possible distance between the strip stabilization and the stripping die increases (see FIG. 4) because of the reduced strip width, an asymmetrical stress distribution or a non-optimal wavy strip profile are less detrimental to the strip stabilization. Due to the stress differences over the strip thickness, an elastic deformation takes place. The stress over the sheet thickness results in the transverse deformation (transverse arching) of the strip above a certain threshold.

Local changes of stress distribution over the sheet thickness due to the outer force influence of the strip stabilization where shown to be dependent on the indicated interrelationship up to the distance from 0.75 to 1.75 times of the strip width in the strip displacement direction.

If a steel strip is subjected to oscillations, e.g., because of a non-round rotation of the stabilizing roller in the zinc vessel, regulation of the strip stabilization permits to achieve reduction of the strip oscillations, in comparison with situation without regulation of the strip stabilization, when the distance of the strip stabilization means from the die slit amounts maximum to 1.5 m. As shown in FIG. 5, the distance threshold value amounts to about 1.5 m for many different typical strip widths. When the strip stabilization means is spaced from the stripping die by a distance greater than this distance threshold value, then, the oscillations in the region of the stripping die are not damped any more but rather can even be simulated, which leads, despite the oscillation damping in the strip stabilization region, to an increased strip movement within the stripping die and, thereby, to reduction of the quality of the coating (FIG. 6).

The same applies to the stabilization/flattening of the strip profile. With distances below the distance threshold value, good flattening is achieved, with distances above the distance threshold value, flattening is difficult or not any more possible.

Further, there is provided a following device for combining strip stabilization means with the stripping die and in which, the strip stabilization coils always act toward a centered strip position.

Contrary to the known systems, the stabilization means must be respectively aligned with the strip position or the actual position is determined. The alignment is effected with additional alignment means.

Due to a specific construction of the frame of the stripping die, the stabilization means is secured on this frame and, thus, is mechanically steady and reproducibly adjustable (FIG. 3). The centering with respect to trip position or the strip center is, thus, always identical between the stabilization means and the stripping die.

Thereby, a possible rotation of the strip during production takes place, and no revaluation of the nill position or the set position of the strip position is necessary. Thus, the stripping dies and the stabilization coils are mechanically synchronized and evaluated.

In Summary,
Determination of the maximum allowable distance between the stabilization means and the stripping die/based on the physical interrelation (Saint Venant's principle) amounts to distance≦φ*strip width.
2. The correction coefficient φ is obtained by simulation and operational tests as a function of a strip width between 1.75 and 0.75. The transverse deformations of the strip result from instability caused by a small strip thickness. At a smaller strip width, those are without a noticeable effect, which results in an increase of possible distances between a strip stabilization means and the stripping die.
3. Integration of the strip stabilization coils within the construction of the stripping die for increasing the alignment precision due to a mechanical connection of the stripping die with the stabilization coils is obtained.
4. The stabilization coils, by being connected with the stripping die, are always identically aligned, even at skewed positions or strip twisting.

1. A method of stabilization of a strip provided with a coating and guided between stripping dies of a hot-dip coating installation, wherein a strip position is detected, and stabilizing forces produced by coils arranged downstream of the stripping dies in a displacement direction of the strip and acting electromagnetically and in contactless manner on the steel strip passing therethrough, are applied to the strip on a basis of the detected strip position,
characterized in that
a distance (of action) of strip stabilization from the stripping dies is adjusted to a value smaller then or equal to a distance threshold value which is determined as a function of the strip width, taking into account a coefficient φ, wherein the coefficient φ is calculated as a function of strip thickness and strip tension.

2. A method according to claim 1,
characterized in that
the distance is adjusted to a smallest possible value, in an ideal case, to a nill.

3. A method according to claim 1,
characterized in that
the strip position is determined within the coil arrangement.

4. A method according to claim 1,
characterized in that
the strip position is determined in a spatial proximity to a coil arrangement.

5. A method according to claim 1,
characterized in that
the strip position is additionally determined above and beneath the coil arrangement.

6. A method according to claim 1,
characterized in that
the distance of the strip stabilization from the stripping dies amounts, according to an actual strip width, to 1.75-0.75 times of the strip width.

7. A method according to claim 1,
characterized in that
the strip position is determined as a local distribution of the distance of the strip with respect to a straight reference line over the strip width, representing an actual profile as an actual measurement value.

8. A method according to claim 7,
characterized in that
the stabilizing forces act on the strip transverse to a displacement direction on the basis of the detected actual strip profile in order to approach the determined actual strip profile to a predetermined optimal set strip profile in form of a flat wave-free strip profile transverse to a strip direction.

9. A method according to claim 1,
characterized in that
the strip position is determined as a timely change of the distance of the strip with respect to a straight reference line, which represents an actual oscillation behavior of the strip dependent on time, as an actual measurement value.

10. A method according to claim 8,
characterized in that
the stabilizing forces act on the strip, in accordance with a detected actual oscillation behavior, preferably, transverse to the conveying direction in order to appropriately damp the detected actual oscillation of the strip, if needed.

11. A method according to claim 7,
characterized in that
the detected strip position represents the oscillation behavior of the strip profile, as a timely and localized, over the strip width, change of the distance of the strip from a straight reference line or as a function of time; and
the stabilizing forces are so suitably applied to the strip so that the strip profile, as far as necessary, is flattened and, simultaneously, has its oscillations damped.

12. A hot-dip coating installation for coating a strip with a coating layer, comprising:
at least one stripping die for removal excessive coating from the strip;
a measuring device for detecting a strip position; and
strip stabilization means with electromagnetic coils arranged, in a strip displacement direction, downstream of the stripping die for generating stabilizing forces acting on the strip in contactless manner in accordance with the detected strip position,
characterized in that
a distance (of action) of the strip stabilization means from the stripping die is adjusted to a value smaller than or equal to V a distance threshold value which is determined as a function of the strip width taking into account a coefficient φ, wherein the coefficient φ is calculated as a function of strip thickness and strip tension.

13. A hot-dip coating installation according to claim 12,
characterized in that
the coils are arranged on upper and bottom sides of the strip in pairs opposite each other, with a variable spacing from the stripping die.

14. A hot-dip coating installation according to claim 12,
characterized in that
that the measuring device is arranged at a height of coils or in their vicinity and detects the strip position there.

15. A hot-dip coating installation according to claim 12,
characterized in that
on the upper and lower sides of the strip, respectively, a plurality of coils are distributed over the strip width, and that outwardly located coils are adjustably arranged, with respect to displaceable strip edges, parallel to a plane of the strip.

16. A hot-dip coating installation according to claim 12,
characterized in that
the strip stabilization means and the measuring device are mechanically connected with a fixed distance therebetween.
